(19) United States
(12) Patent Application Publication
(10) Pub. No.: US 2026/0023180 A1
(43) Pub. Date: Jan. 22, 2026

(54) ULTRASONIC SENSOR UNIT FOR A VEHICLE

(71) Applicant: Robert Bosch GmbH, Stuttgart (DE)

(72) Inventors: Kartik Hanamasagar, Bengaluru (IN); Srikanta Tunga, Bengaluru (IN); Stevens Wang, Stuttgart (DE); Daniel Ebert, Rutesheim (DE); Juergen Schmidt, Sindelfingen (DE); Pascal Sylvain Meysonnat, Stuttgart (DE); Tom Reimann, Bissingen An Der Teck (DE)

(21) Appl. No.: 19/268,277

(22) Filed: Jul. 14, 2025

(30) Foreign Application Priority Data
Jul. 18, 2024 (DE) 10 2024 206 738.5

(51) Int. Cl. G01S 15/931; B60W 30/095; B60W 50/00; G01S 7/52; G01S 7/539

(52) U.S. Cl. CPC G01S 15/931; B60W 30/0956; B60W 50/0098; G01S 7/52003; G01S 7/539; B60W 2420/54

(57) ABSTRACT

An ultrasonic sensor unit for a vehicle. The ultrasonic sensor unit is configured to emit first, second, and third ultrasonic waves. The ultrasonic sensor unit is configured to receive and/or detect a movement path with the ultrasonic sensor unit. The ultrasonic sensor unit is configured to detect first, second, and third reflection, of the first, second, and third ultrasonic wave, of an object. The ultrasonic sensor unit is configured to ascertain a first intersection point between the first reflection and the second reflection, a second intersection point between the second reflection and the third reflection, and a first ellipse based on the first intersection point, the second intersection point and the movement path. The ultrasonic sensor unit is configured to determine a type of the object based on the first ellipse.

### FIELD

The present application claims the benefit under 35 U.S.C. § 119 of German Patent Application No. 10 2024 206 738.5 filed on Jul. 18, 2024, which is expressly incorporated herein by reference in its entirety.

### FIELD

The present invention relates to an ultrasonic sensor unit for a vehicle, and to a vehicle.

### BACKGROUND INFORMATION

There is currently a large number of different solutions for evaluating ultrasonic data in the vehicle sector. Due to the increasing number of ultrasonic sensors on vehicles as well as the increased quality and accuracy requirements, the need for innovative and robust methods for evaluating ultrasonic data is constantly growing.

Continuous weight reduction in the vehicle sector for reducing consumption and increasing competition are putting pressure on costs, and therefore cheaper and more efficient components for vehicles are in greater demand.

### SUMMARY

An ultrasonic sensor unit according to the present invention for a vehicle may have the advantage over the conventional units that the differentiation between different objects can be improved with the aid of the ellipse fitting algorithm. The algorithm preferably contributes substantially to improving the accuracy of object localization by reducing the influence of outliers in the ultrasonic echo data. By forming and fitting an ellipse to the echo data, it is possible to estimate the true position of the object more accurately, although some of the measurements may be adversely affected by noise or outliers. If this process is repeated during the driving movement, more detailed information about the shape and structure of the object can be extracted, which can be useful for the classification of complex object contours.

This is achieved according to an example embodiment of the present invention in that the ultrasonic sensor unit for a vehicle is configured to emit a first ultrasonic wave, a second ultrasonic wave and a third ultrasonic wave, wherein the ultrasonic sensor unit is configured to receive and/or detect a movement path of the ultrasonic sensor unit, wherein the ultrasonic sensor unit is configured to detect a first reflection of the first ultrasonic wave of the object, a second reflection of the second ultrasonic wave of the object, and a third reflection of the third ultrasonic wave of the object, wherein the ultrasonic sensor unit is configured to ascertain a first intersection point between the first reflection and the second reflection, wherein the ultrasonic sensor unit is configured to ascertain a second intersection point between the second reflection and the third reflection, wherein the ultrasonic sensor unit is configured to ascertain a first ellipse based on the first intersection point, the second intersection point and the movement path, wherein the ultrasonic sensor unit is configured to determine a type of the object based on the first ellipse.

In other words, by forming the first ellipse based on the ultrasound measurements along the movement path of the vehicle, the type of the detected object can be determined. Preferably, the movement path can in particular be a movement that the ultrasonic sensor unit performs for a predetermined period of time. Preferably, the movement path can in particular be the movement of a vehicle in which the ultrasonic sensor unit is installed. Preferably, an orientation of the ultrasonic sensor unit or an emission direction of the first ultrasonic wave, the second ultrasonic wave and/or the third ultrasonic wave can be substantially orthogonal to the direction of travel of the vehicle. One input of the recognition phase is the side-object buffer, which can consist of a list of “side objects” specified by a class with defined properties and attributes. Initially, each “side object” preferably contains only one segment of historical sensor data, so-called echoes or reflections, measured by ultrasonic sensors. Each echo or reflection can be visualized as a semicircle, wherein the echo distance (derived from the travel time of the ultrasonic waves in the air) can be used as the radius. Initially, the intersection points of the echoes in 2D space can be calculated.

Based on the derived ellipse parameters, the object type classification is preferably performed, wherein a safety (reliability) value is ascertained for each object type. Point and line safety values are preferably derived from the eccentricity and the semi-axes of the first ellipse, divided by the traveled distance and the rotation angle of the first ellipse for the echoes under consideration. The result of the recognition phase is preferably an updated list of “side objects,” with which the type of each side object is determined if the ellipse fitting was successful.

Preferred developments of the present invention are disclosed herein.

According to an example embodiment of the present invention, preferably, the ultrasonic sensor unit is configured to assign the object to a point contour or a line contour based on the first ellipse.

An advantage of this example embodiment is that, based on the shape of the first ellipse, the ultrasonic sensor unit can classify the object as either a line contour or a point contour for further processing.

According to an example embodiment of the present invention, preferably, the ultrasonic sensor unit is configured to ascertain an eccentricity of the first ellipse, wherein the ultrasonic sensor unit is configured to assign the point contour or the line contour to the object based on the eccentricity.

An advantage of this example embodiment is that by evaluating the eccentricity of the first ellipse, the point contour or the line contour can be assigned to the object with the aid of a simple observation, in order to thus be able to save computing resources. The eccentricity of an ellipse can be calculated as the ratio of the length of its semi-axis to the distance from its center to one of its focal points. This variable preferably describes the degree of flattening of the ellipse.

More preferably, according to an example embodiment of the present invention, the ultrasonic sensor unit is configured to assign the point contour to the object if the eccentricity tends toward zero, or to assign the line contour to the object if the eccentricity tends toward one.

An advantage of this example embodiment is that, with the aid of the defined states, a simpler distinction can be made between a point object and a line object. “Tends toward zero” means in particular that the eccentricity value is less than 0.5. More preferably, “tends toward one” means that the eccentricity value is greater than 0.5. Preferably, an eccentricity of zero indicates that the ellipse is very close to a circle or a point, while an eccentricity of one indicates that the ellipse is more like a straight line.

Preferably, according to an example embodiment of the present invention, the ultrasonic sensor unit is configured to ascertain a driving probability based on a width of the first ellipse and on the movement path, wherein the ultrasonic sensor unit is configured to assign the point contour or the line contour to the object based on the driving probability.

An advantage of this example embodiment is that, with the aid of the vectorization of the movement path as well as the width of the first ellipse, it is easy to compare whether there is a high likelihood of the ultrasonic sensor unit driving or moving, in order to thus be able to infer a point contour or a line contour. The higher the driving probability, the more likely the object is to be associated with a line contour. The driving probability of an ellipse can be defined as the ratio of its width to the distance traveled by the ultrasonic sensor unit and/or by a vehicle. An ellipse with a driving probability of zero is preferably of the point object type, while an ellipse with a driving probability of one is of the line object type. The more scattered the points are, the higher the probability that the object is a line.

According to an example embodiment of the present invention, preferably, the ultrasonic sensor unit is configured to ascertain a phi probability based on an angle between a semi-major axis of the first ellipse and a reference, wherein the ultrasonic sensor unit is configured to assign the point contour or the line contour to the object based on the phi probability.

An advantage of this example embodiment is that, with the aid of the evaluation of the phi probability, accuracy in object recognition or in the recognition of point contours or line contours can be improved, in order to thus be able to contribute, in particular in conjunction with the driving probability as well as the eccentricity, to increased object detection accuracy. Preferably, the reference may in particular be an X-axis into which the first ellipse is transferred. The phi probability of an ellipse is preferably determined using the angle phi, which its semi-axis forms together with the x-axis, divided by one half of n. If the phi probability is greater than 0.5, the ellipse has an angle greater than 45 degrees, which is more likely to occur for a point-like contour than for a line-like contour, for which this probability would be close to zero.

More preferably, according to an example embodiment of the present inventio, the ultrasonic sensor unit is configured to determine a position of the object based on a center point of the first ellipse.

An advantage of this example embodiment is that, with the aid of the first ellipse, a reference is established in which a context can be formed between the position of the ultrasonic sensor unit and a position of the object.

Preferably, according to an example embodiment of the present invention, the ultrasonic sensor unit is configured to ascertain a center of gravity based on the first intersection point and the second intersection point, wherein the ultrasonic sensor unit is configured to fit the first ellipse based on the center of gravity.

An advantage of this example embodiment is that possible errors when creating the first ellipse can be avoided in a targeted manner by taking the center of gravity into account. Preferably, the center of gravity of the point cloud can be calculated by calculating the mean of all intersection points. In order to avoid potential overflows and underflows in the value range, the center of gravity becomes the origin of the 2D coordinate system during execution.

More preferably, according to an example embodiment of the present invention, the ultrasonic sensor unit is configured to form a point matrix and/or scatter matrix based on the first intersection point and the second intersection point, wherein the ultrasonic sensor unit is configured to ascertain an eigenvalue for each entry of the point matrix, wherein the ultrasonic sensor unit is configured to fit the first ellipse based on the eigenvalue of the entries of the point matrix.

An advantage of this example embodiment is that the profile of the first ellipse can be optimized by minimizing the eigenvalues. Once the intersection points and/or the center of gravity are given, the fitting of the first ellipse can be carried out. This process preferably begins with the calculation of the point matrix used in principal component analysis (PCA) in order to identify the principal components of the data. Preferably, according to an example embodiment of the present invention, the point matrix is derived from the design matrices and the constraint matrix.

Preferably, according to an example embodiment of the present invention, the eigenvalues and eigenvectors of the point matrix can be ascertained. The minimum eigenvector values are preferably determined with respect to the first ellipse. These minimum eigenvector values are used to calculate the coefficients for a conic section equation that preferentially defines the ellipse. From this, the ellipse parameters can preferably be derived. At the end, an inverse transformation is performed in order to return the intersection points to their original position.

Preferably, according to an example embodiment of the present invention, the recognition phase is prioritized in order to identify and classify objects detected by the ultrasonic sensors. With the aid of historical sensor data, the ultrasonic sensor unit can accurately calculate the intersection points and center of gravity, and then fit an ellipse to the data in order to determine the object type. The positioning of objects, in particular side objects, preferably differs in relation to their type. When considering a point object, the center of the ellipse is preferably used as the position of the side object. In the case of a line object, the tangent is preferably calculated using the most recent and stored echo circles. In addition, it is preferable to take into account how objects between a distinct point and a distinct line object can be modeled. These objects can be represented either as two point objects (focal points of the ellipse) or as a short line object (semi-axis of the ellipse).

A further aspect of the present invention relates to a vehicle that comprises an ultrasonic sensor unit for a vehicle according to the present invention, as described above and below.

### BRIEF DESCRIPTION OF THE DRAWINGS

Exemplary embodiments of the present invention are described in detail with reference to the figures.

FIG. 1 shows an ultrasonic sensor unit according to one example embodiment of the present invention.

FIG. 2 shows a vehicle according to one example embodiment of the present invention.

FIGS. 3 to 5 are each a diagram for illustrating the functioning of the ultrasonic sensor unit according to one example embodiment of the present invention.

FIG. 6 is a flow chart for illustrating the functioning of the ultrasonic sensor unit according to one example embodiment of the present invention.

FIGS. 7 and 8 are each a diagram for illustrating the functioning of the ultrasonic sensor unit according to one example embodiment of the present invention.

### DETAILED DESCRIPTION OF EXAMPLE EMBODIMENT

Preferably, all the same elements, units and/or steps in all figures are provided with the same reference signs.

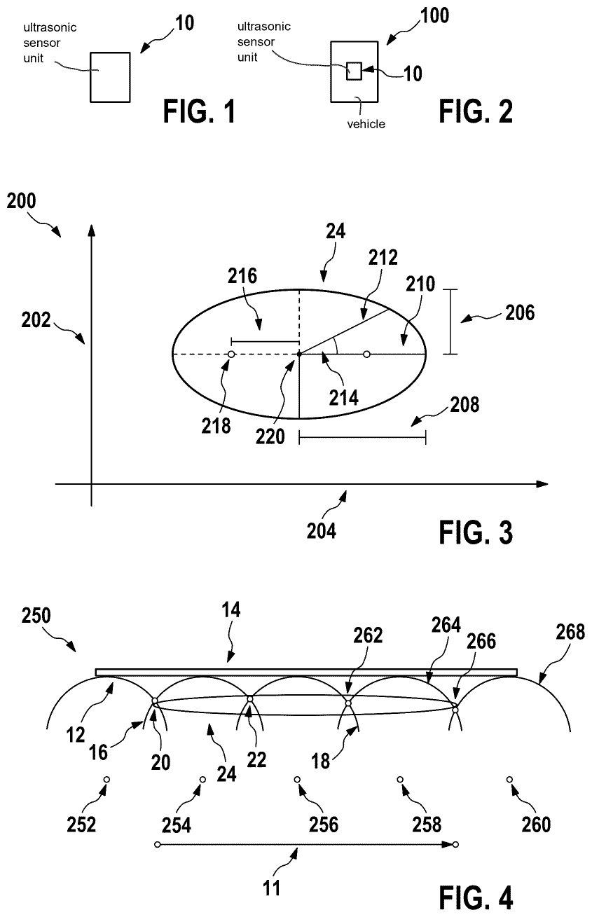

FIG. 1 shows an ultrasonic sensor unit 10 for a vehicle 100 according to one embodiment. The ultrasonic sensor unit 10 is configured to emit a first ultrasonic wave, a second ultrasonic wave and a third ultrasonic wave, wherein the ultrasonic sensor unit 10 is configured to receive and/or detect a movement 11 of the ultrasonic sensor unit 10, wherein the ultrasonic sensor unit 10 is configured to detect a first reflection 12 of the first ultrasonic wave of an object 14, a second reflection 16 of the second ultrasonic wave of the object 14, and a third reflection 18 of the third ultrasonic wave of the object 14, wherein the ultrasonic sensor unit 10 is configured to ascertain a first intersection point 20 between the first reflection 12 and the second reflection 16, wherein the ultrasonic sensor unit 10 is configured to ascertain a second intersection point 22 between the first reflection 12 and the third reflection 18, wherein the ultrasonic sensor unit 10 is configured to ascertain a first ellipse 24 based on the first intersection point 20, the second intersection point 22 and the movement path 11, wherein the ultrasonic sensor unit 10 is configured to determine a type of the object 14 based on the first ellipse 24.

FIG. 2 shows a vehicle 100 according to one embodiment. The vehicle 100 preferably comprises an ultrasonic sensor unit 10 for a vehicle, as described above and below.

FIG. 3 is a diagram 200 for illustrating the functioning of the ultrasonic sensor unit 10 according to one embodiment. The diagram 200 comprises a first axis 202 on which the echo distance is plotted. More preferably, the diagram 200 comprises a second axis 204 on which time is plotted. More preferably, the first ellipse 24 is shown in the diagram 200. The first ellipse 24 comprises a first semi-subaxis 206 as well as a first semi-major axis 208. More preferably, the first ellipse 24 comprises a center 220. Preferably, a phi angle 214 can be formed between a reference 210 and a semi-major axis 208 of the first ellipse 24. More preferably, a first variable 216 can be formed between the focus 218 and the center 220. Based on a ratio between the first semi-major axis 208 and the distance 216, the eccentricity of the first ellipse 24 can be determined.

FIG. 4 is a diagram 250 for illustrating the functioning of the ultrasonic sensor unit 10 according to one embodiment. FIG. 4 shows an object 14 that comprises a line contour. The ultrasonic wave can cause a first reflection 12, a second reflection 16 and a third reflection 18. More preferably, a first intersection point between the first reflection 12 and the second reflection 16 of the object 14 can be ascertained. More preferably, a second intersection point 22 can be formed based on the second reflection 16 and the third reflection 18 of the ultrasonic waves at the object 14. Based on the first intersection point 20 and the second intersection point 22, the first ellipse 24 can be ascertained. More preferably, a plurality of further reflections and intersection points can also be used for forming the first ellipse 24. FIG. 4 shows a fourth reflection 264 and a fifth reflection 268. Preferably, a third intersection point 262 can be formed between the third reflection 18 and the fourth reflection 264. More preferably, a fourth intersection point can be ascertained based on the fourth reflection 264 and the fifth reflection 268. Preferably, the first ellipse 24 can also comprise the third intersection point 262 as well as the fourth intersection point 266. More preferably, a first position 252 of the ultrasonic sensor unit 10 is shown when creating the first reflection 12. More preferably, a second point 254 of the ultrasonic sensor unit 10, at which the second reflection 16 was ascertained, is shown. More preferably, a plurality of further points 256, 258, 260, at each of which a reflection could be ascertained, are shown. More preferably, the movement path 11 of the ultrasonic sensor unit 10 is shown in FIG. 4.

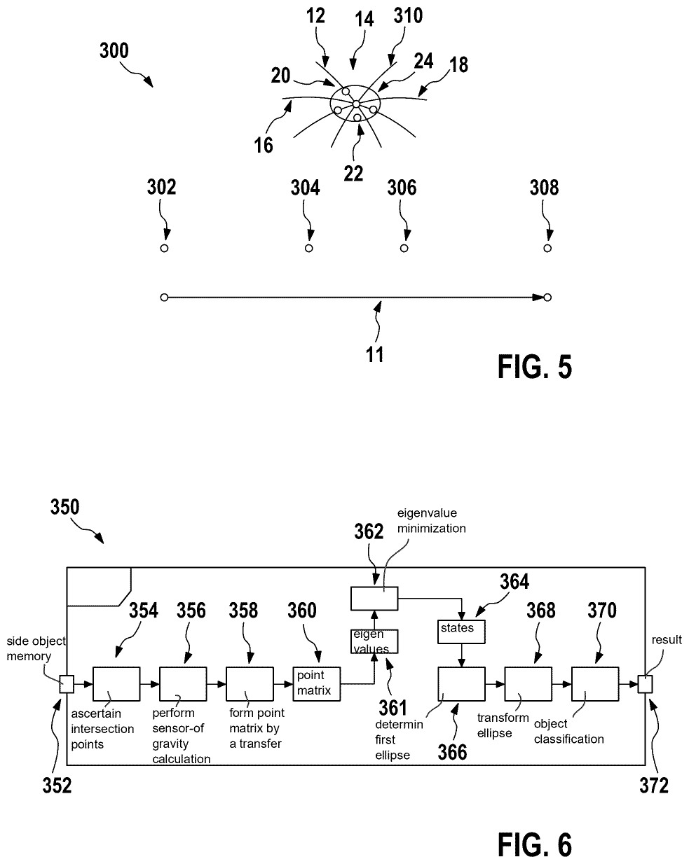

FIG. 5 is a diagram 300 for showing the functioning of the ultrasonic sensor unit 10 according to one embodiment. In FIG. 5, an object 14 that comprises a point contour is shown. Similar to FIG. 4, based on the first reflection 12, the second reflection 16 and the third reflection 18 on the object 14, a first intersection point 20 and a second intersection point 22 can be formed. Based on the first intersection point 20 and the second intersection point 22, the first ellipse 24 can be determined. As can be seen from the comparison of FIGS. 4 and 5, an extension width of the first ellipse 24 in FIG. 5 is significantly smaller than in FIG. 4, since the object is a point contour. More preferably, the ultrasonic sensor unit 10 can ascertain the first reflection 12 at a first position 302, the second reflection 16 at a second position 304, the third reflection 18 at a third position 306, and the further reflection 310 at a fourth position 308. Thus, in particular, the movement path 11 can be put into a context with the determination of the reflections.

FIG. 6 is a flow chart 350 for illustrating the functioning of the ultrasonic sensor unit 10 according to one embodiment. The intersection points can be ascertained from a side object memory 352 in step 354. Based on the intersection points, a center-of-gravity calculation 356 can be performed. More preferably, a point matrix 360 can be formed by means of a transfer 358. Based on the point matrix 360, the eigenvalues 361 of the entries of the point matrix 360 can be calculated. More preferably, the eigenvalue minimization 362 can take place based on the eigenvalues 360. Preferably, states 364 of the first ellipse 24 can be ascertained. In step 366, the first ellipse 24, in particular parameters of the ellipse, can be determined. In step 368, the ellipse can be transformed in order to be able to perform an object classification 370. The result 372 is a type of the object 14.

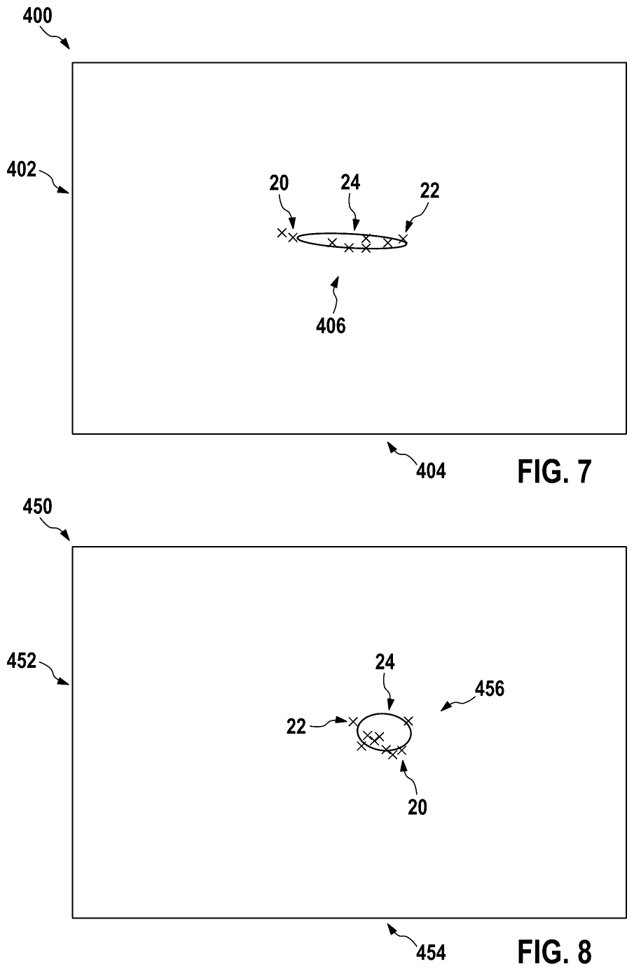

FIG. 7 is a diagram 400 for illustrating the functioning of the ultrasonic sensor unit 10 according to one embodiment. In the diagram 400 there is a first axis 402 on which the echo distance is plotted. More preferably, there is a second axis 404 on which time is plotted. As can be seen in FIG. 7, there are a plurality of intersection points 406 that comprise the first intersection point 20 and the second intersection point 22 in order to thus be able to form a first ellipse 24. As can be seen in FIG. 7, due to the width of the first ellipse, the object is highly likely to have a linear contour.

FIG. 8 is a diagram 450 for illustrating the functioning of the ultrasonic sensor unit 10 according to one embodiment. The diagram 450 comprises a first axis 452 with an echo distance, and a second axis 454 with a time. The diagram 450 comprises a plurality of intersection points 456, which comprise the first intersection point 20 and the second intersection point 22. Preferably, the first ellipse 24 can be formed based on the plurality of intersection points 456. As can be seen in FIG. 8, due to the small width of the ellipse 24, a point-like contour of the object can be assumed.

What is claimed is:

1. An ultrasonic sensor unit for a vehicle, configured to:
emit a first ultrasonic wave, a second ultrasonic wave and a third ultrasonic wave;
receive and/or detect a movement path using the ultrasonic sensor unit;
detect a first reflection of the first ultrasonic wave of an objec, a second reflection of the second ultrasonic wave of the object, and a third reflection of the third ultrasonic wave of the object;
ascertain a first intersection point between the first reflection and the second reflection;
ascertain a second intersection point between the second reflection and the third reflection;
ascertain a first ellipse based on the first intersection point, the second intersection point, and the movement path; and
determine a type of the object based on the first ellipse.

2. The ultrasonic sensor unit according to claim 1, wherein the ultrasonic sensor unit is configured to assign a point contour or a line contour based on the first ellipse of the object.

3. The ultrasonic sensor unit according to claim 2, wherein the ultrasonic sensor unit is configured to ascertain an eccentricity of the first ellipse, and wherein the ultrasonic sensor unit is configured to assign the point contour or the line contour to the object based on eccentricity.

4. The ultrasonic sensor unit according to claim 3, wherein the ultrasonic sensor unit is configured to assign the point contour to the object when the eccentricity tends toward zero, and/or to assign the line contour to the object when the eccentricity tends toward 1.

5. The ultrasonic sensor unit according to claim 2, wherein the ultrasonic sensor unit is configured to determine a driving probability based on a width of the first ellipse and the movement path, and wherein the ultrasonic sensor unit is configured to assign the point contour or the line contour to the object based on the driving probability.

6. The ultrasonic sensor unit according to claim 2, wherein the ultrasonic sensor unit is configured to ascertain a phi probability based on an angle between a semi-major axis of the first ellipse and a reference, and wherein the ultrasonic sensor unit is configured to assign the point contour or the line contour to the object based on the phi probability.

7. The ultrasonic sensor unit according to claim 1, wherein the ultrasonic sensor unit is configured to determine a position of the object on a center point of the first ellipse.

8. The ultrasonic sensor unit according to claim 1, wherein the ultrasonic sensor unit is configured to ascertain a center of gravity based on the first intersection point and the second intersection point, wherein the ultrasonic sensor unit is configured to fit the first ellipse based on the center of gravity.

9. The ultrasonic sensor unit according to claim 1, wherein the ultrasonic sensor unit is configured to form a point matrix based on the first intersection point and the second intersection point, wherein the ultrasonic sensor unit is configured to ascertain an eigenvalue for each entry of the point matrix, and wherein the ultrasonic sensor unit is configured to fit the first ellipse based on the eigenvalue of the entries of the point matrix.

10. A vehicle, comprising:
an ultrasonic sensor unit for the vehicle, wherein the ultrasonic sensor unit is configured to:
emit a first ultrasonic wave, a second ultrasonic wave and a third ultrasonic wave,
receive and/or detect a movement path using the ultrasonic sensor unit,
detect a first reflection of the first ultrasonic wave of an objec, a second reflection of the second ultrasonic wave of the object, and a third reflection of the third ultrasonic wave of the object,
ascertain a first intersection point between the first reflection and the second reflection,
ascertain a second intersection point between the second reflection and the third reflection,
ascertain a first ellipse based on the first intersection point, the second intersection point, and the movement path, and
determine a type of the object based on the first ellipse.
